(19) United States
(12) Patent Application Publication
(10) Pub. No.: US 2014/0095226 A1
(43) Pub. Date: Apr. 3, 2014

(54) SYSTEM AND METHOD FOR DYNAMIC BARCODE GENERATION RELATED TO EVENT TICKETING

(71) Applicant: Redbox Automated Retail, LLC, Oakbrook Terrace, IL (US)

(72) Inventors: Alex Kourkoumelis, Lake In The Hills, IL (US); Sorin Petrea, Glenview, IL (US); Dinesh Patel, Markham (CA); Adam Richard Fischer, Willowbrook, IL (US)

(21) Appl. No.: 14/042,638

(22) Filed: Sep. 30, 2013

Related U.S. Application Data
(60) Provisional application No. 61/741,775, filed on Oct. 3, 2012.

(51) Int. Cl. G06Q 10/02

(52) U.S. Cl. CPC G06Q 10/02
USPC 705/5

(57) ABSTRACT

A system and method of dynamically generating ticket barcodes for ticket orders is disclosed. A ticket order including tickets related to an event may be received from an article dispensing machine or another source. Random barcodes can be generated as the basis for the ticket barcodes. The ticket barcodes can be generated based on barcode attributes unique to a ticket supplier or a venue of the event. Such barcode attributes can include a barcode prefix, a barcode suffix, a barcode total length, and a barcode symbology. When the tickets in a ticket order are ready to be produced, images of the ticket barcodes can be generated and assigned based on the barcode attributes. The user experience for purchasing tickets from disparate ticket suppliers and/or venues can accordingly be simplified and streamlined.

### CROSS-REFERENCE TO RELATED APPLICATIONS

This application claims priority to U.S. Provisional Application No. 61/741775 which was filed on Oct. 3, 2012, entitled “SYSTEM AND METHOD FOR DYNAMIC BARCODE GENERATION RELATED TO EVENT TICKETING” which is hereby incorporated herein by reference in its entirety.

### TECHNICAL FIELD

This invention relates to a system and method for dynamic barcode generation related to event ticketing. More particularly, the present invention provides a system and method for dynamically generating ticket barcodes for tickets of a ticket order, where the ticket barcodes are based on barcode attributes, such as a barcode prefix, a barcode suffix, a barcode total length, and a barcode symbology.

### BACKGROUND AND SUMMARY OF THE INVENTION

While the present invention is often described herein with reference to a digital video disc, Blu-Ray disc, video game, and event ticketing distribution system, an application to which the present invention is advantageously suited, it will be readily apparent that the present invention is not limited to that application and can be employed in article dispensing systems used to distribute a wide variety of dispensable articles.

The digital video disc (DVD) player has been one of the most successful consumer electronics product launches in history. The market for DVD movie video, Blu-Ray movie video, and video game rentals is enormous and growing. Millions of households have acquired DVDs since they were introduced in 1997. In the first quarter of 2003 alone, it was estimated that well over three million DVD players were shipped to U.S. retailers.

In 2003, brick-and-mortar stores dominated the movie video and video game rental landscape in the U.S. Statistics showed that two brick-and-mortar companies controlled nearly sixty-five percent of the home video rental business. One element repeatedly cited for success of certain brick-and mortar store video rental franchises was perceived high availability of new video releases. Consumers want entertainment on demand, and through stocking multiple units of each new release, successful brick-and-mortar companies meet this consumer demand.

The foregoing indicates that there is a significant market potential for aligning regular routines of consumers (e.g., shopping, getting coffee, gas, or going to a convenience store) with their DVD, Blu-Ray, and video game rental activities. Moreover, there is a significant market potential for aligning the regular routines of consumer with event ticketing activities.

One improved article dispensing machine is disclosed in commonly owned U.S. Pat. No. 7,234,609, which is herein incorporated by reference in its entirety. The invention of the U.S. Pat. No. 7,234,609 and the present invention can function as an article dispensing machine-based distribution system that will typically have multiple units per article dispensing machine. The dispensing machines of the U.S. Pat. No. 7,234,609 and the present invention can stock up to two thousand DVDs, Blu-Ray, video games, or other discs (movies, games or other entertainment content), making the system competitive with existing brick-and-mortar video rental superstores. The dispensing machines can also provide event ticketing capabilities to make the system competitive with other event ticketing schemes. The dispensing machine and system of the U.S. Pat. No. 7,234,609 and the present invention distinguishes itself from stores and other event ticketing schemes by offering major benefits not conventionally offered by such stores, including additional cross-marketing programs (e.g., promotional rentals for a certain amount of dollars spent at the retail location) and convenience (e.g., open always).

The dispensing machine of the U.S. Pat. No. 7,234,609 and the present invention yields a competitive advantage in the DVD, Blu-Ray disc, video game, and event ticketing marketplace by offering consumers cross-marketing/promotional programs, convenience of selection (e.g., computer-based searches for movies and recommendations based on consumer profiles), and potentially extended hours (e.g., 24 hours a day, 7 days a week). The present invention employs a more cost-effective, convenient platform than brick-and-mortar stores and existing event ticketing schemes. In addition, with the present invention, dispensing machines can be situated in retail locations having high foot traffic, such as at a popular grocery store, restaurant, drug store, and/or other popular retail location.

The dispensing machine of the U.S. Pat. No. 7,234,609 and the present invention can be operated at a substantial savings over the costs associated with traditional brick-and-mortar stores. For example, the present invention does not require hourly employees manning the dispensing machines or restocking them with inventories, due to the ability of the article transport storage units to be delivered to/picked up from retail locations by third-party delivery services, such as traditional or contracted courier services.

Unlike brick-and-mortar stores, the dispensing machine of the U.S. Pat. No. 7,234,609 and the present invention does not require an on-site store manager because all operational decisions can be made at a centralized location by a management team officed remote from the retail locations. Unlike brick-and-mortar stores, the dispensing machine of the U.S. Pat. No. 7,234,609 and the present invention does not require significant physical space. Unlike brick-and-mortar stores, the dispensing machine of the U.S. Pat. No. 7,234,609 and the present invention has low operating costs because heating or air conditioning is not necessarily required for the dispensing machines and they consume a relatively low level of electrical energy. In addition, the dispensing machine of the U.S. Pat. No. 7,234,609 has low maintenance costs and downtime.

The dispensing machine of the U.S. Pat. No. 7,234,609 and the present invention addresses the shortcomings of traditional brick-and-mortar stores in a convenient and cost-effective delivery vehicle having the added bonus of serving as an effective promotional platform that drives incremental sales to retail locations.

The dispensing machine of the U.S. Pat. No. 7,234,609 and the present invention is a fully automated, integrated DVD, Blu-Ray, video game, and event ticketing system. It preferably incorporates robust, secure, scalable software that provides a fully personalized user experience and real-time feedback to retail locations and advertisers, scalable hardware that leverages existing technologies such as touch screen, focused audio speakers and video monitors, and technology utilizing the Internet through a system website or mobile/consumer electronics device application. These technologies and others fill long-felt needs in the art. The dispensing machine of the U.S. Pat. No. 7,234,609 and the present invention functions as much as a promotional platform as it does a rental and purchase kiosk.

By utilizing the dispensing machines and the fully-interactive, real-time, linked Internet website or mobile/consumer electronics device applications, consumers can rent one or more DVDs, Blu-Ray discs, video games, or other entertainment content directly from dispensing machines as well as indirectly by making a rental reservation through the website or application for later pickup at a conveniently located machine. Consumers can also initiate and/or complete event ticketing transactions utilizing the dispensing machines. These dispensing machines are preferably networked with each other, with the inventory control and/or supply office and with the system website or application by phone-line, DSL, wireless network, or other Internet connection at each retail location. Through this linked network, the experience for each consumer can be customized based on a profile for each consumer, such as via personalized home pages and screens.

The present invention may dynamically generate a ticket barcode for the tickets of a ticket order. The ticket order may be received from an article dispensing machine or another source. The ticket order can be related to an event having one or more productions. A production of an event is a particular performance of the event at a certain date, time, and venue. Bearers of the tickets included in the ticket order can gain admission to the event at a venue. Each ticket supplier and/or particular venue may utilize unique barcode attributes, e.g., a barcode prefix, a barcode suffix, a barcode total length, and a barcode symbology. The system and method of the present invention can generate random barcodes for productions of events at the venue, based on the barcode attributes. The random barcodes may be the basis of the ticket barcodes. A ticket barcode can be generated that is readable by an admission control system at the venue. The user experience for purchasing tickets from disparate ticket suppliers and/or venues can accordingly be simplified and streamlined.

Other features and advantages are provided by the following description and drawings.

### BRIEF DESCRIPTION OF THE DRAWINGS

FIG. 1 is an illustration of a system for communicating and processing information in a network of article dispensing machines and dispensing apparatus.

FIG. 2 is a perspective view of an article dispensing machine constructed in accordance with the principles of the present invention.

FIG. 3 is a block diagram illustrating a networked event ticketing system and connections including an article dispensing machine, an event ticketing management system, and ticket supplier systems.

FIG. 4 is a flowchart illustrating operations for managing a ticket order transaction at an article dispensing machine.

FIG. 5 is a flowchart illustrating operations for dynamically generating ticket barcodes for tickets of a ticket order.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

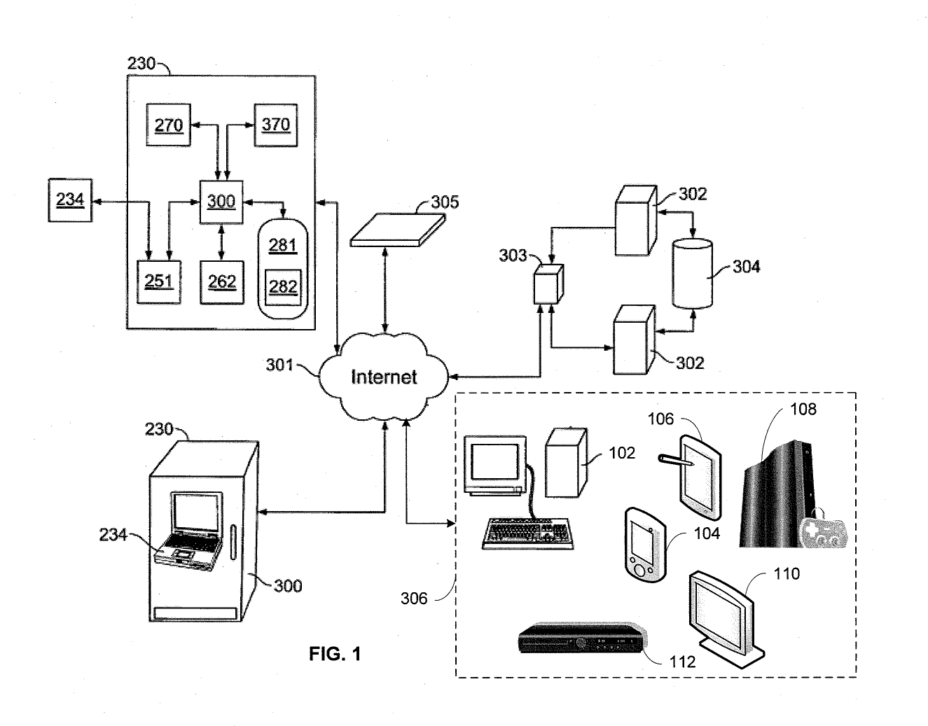

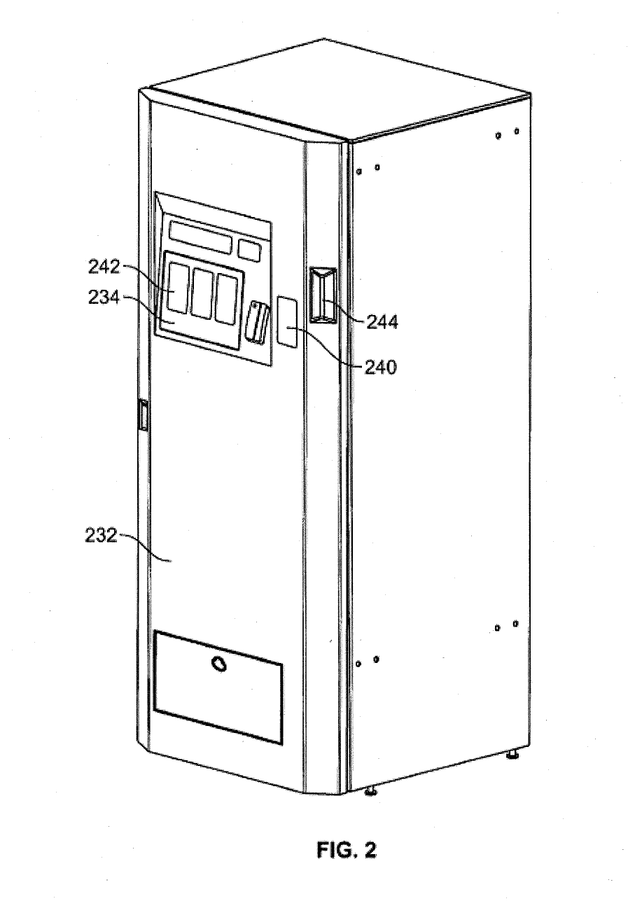

FIGS. 1-2 illustrate an article dispensing machine designated 230. Article dispensing machine 230 is one of a plurality of article dispensing machines included within an article distribution system having a plurality of such machines situated at a plurality of retail locations. The article dispensing machines of a particular article distribution system preferably form a network. As such, those machines are preferably in electrical communication with each other and with a central server or central controller.

As shown in FIG. 1, each article dispensing machine 230 includes a dispensing machine processor 300, also referred to herein as a vending controller, which is connected to a first sensor 270 and a second sensor 370, a first motor 251 and a second motor 262 and a user interface control system 234, collectively referred to as “the peripheral devices.” The processor is capable of executing various programs to provide input to and/or receive outputs from the peripheral devices. Suitable processors for such use are known to those of skill in the art. In addition, the processor is operably connected to at least one memory storage device 281, such as a hard-drive or flash-drive or other suitable memory storage device.

Article dispensing machine memory storage device 281 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, article dispensing machine memory storage device 281 may incorporate electronic, magnetic, optical, and/or other types of storage media. Article dispensing machine memory storage device 281 can have a distributed architecture where various components are situated remote from one another, but are still accessed by processor. Article dispensing machine memory storage device includes an article dispensing machine database 282.

The article dispensing machines 230 preferably comprise a network of machines in communication with one another. As shown in FIG. 1, in the preferred configuration, the article dispensing machines 230 are networked with one another via a central server or central controller 302 in a hub-and-spoke system. However, optionally, the article dispensing machines may be connected and communicate directly with one another, and/or subsets of article dispensing machines may communicate with one another directly as well as with the central server 302.

Generally, in terms of hardware architecture, the central server 302 can include a central processor and/or controller, central memory, and one or more input and/or output (I/O) devices (or peripherals) that are communicatively coupled via a local interface. The architecture of the central server 302 is set forth in greater detail in U.S. Pat. No. 7,234,609, the contents of which are incorporated herein by reference. Numerous variations of the architecture of the central server 302 would be understood by one of skill in the art and are encompassed within the scope of the present invention.

The processor/controller is a hardware device for executing software, particularly software stored in memory. The processor can be any custom made or commercially available processor, a central processing unit (CPU), an auxiliary processor among several processors associated with the server 302, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. The processor may also represent a distributed processing architecture such as, but not limited to, SQL, Smalltalk, APL, KLisp, Snobol, Developer 200, MUMPS/Magic.

The software in memory may include one or more separate programs. The separate programs comprise ordered listings of executable instructions for implementing logical functions. The software in memory includes a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers, smartphones, or personal digital assistants (PDAs) (e.g., PalmOS available from Palm Computing, Inc., Windows CE or Windows Phone available from Microsoft Corporation, iOS available from Apple Inc, Android available from Google Inc., BlackBerry OS available from Research in Motion Limited, Symbian available from Nokia Corp.). The operating system essentially controls the execution of other computer programs and provides scheduling, input-output control, file and data management, memory management, and communication control and related services.

Steps and/or elements, and/or portions thereof of the present invention may be implemented using a source program, executable program (object code), script, or any other entity comprising a set of instructions to be performed. When a source program, the program needs to be translated via a compiler, assembler, interpreter, or the like, which may or may not be included within the memory, so as to operate properly in connection with the operating system (O/S). Furthermore, the software embodying the present invention can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, Ada, and Lua.

When article dispensing machine 230 is in operation, the article dispensing machine processor is configured to execute software stored within article dispensing machine memory, to communicate data to and from the dispensing machine memory, and to generally control operations of article dispensing machine pursuant to the software. The software aspects of the present invention and the O/S, in whole or in part, but typically the latter, are read by processor, perhaps buffered within the processor, and then executed.

When the present invention or aspects thereof are implemented in software, it should be noted that the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The present invention can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

For communication with the central server 302, article dispensing machine 230 is equipped with network communication equipment and circuitry. In a preferred embodiment, the network communication equipment includes a network card such as an Ethernet card. In a preferred network environment, each of the plurality of article dispensing machines 230 on the network is configured to use the TCP/IP protocol to communicate via the network 301. It will be understood, however, that a variety of network protocols could also be employed, such as IPX/SPX, Netware, PPP, and others. It will also be understood that while a preferred embodiment of the present invention is for article dispensing machine 230 to have a “broadband” connection to the network 301, the principles of the present invention are also practicable with a dialup connection using a standard modem. Wireless network connections are also contemplated, such as wireless Ethernet, satellite, infrared, radio frequency, Bluetooth, near field communication, and cellular networks.

The central controller 302 communicates with the article dispensing machine controllers 300 via the network 301. The central controller 302 is preferably located at a central station or office that is remote from the plurality of article dispensing machines 230. The central controller 302 can operate as the server for communicating over the network 301 between the plurality of article dispensing machines 230. The central controller 302 receives communications and information from the article dispensing machines 230, and also transmits communications and information to the machines 230. For example, when a rental transaction is performed at the article dispensing machine 230, transaction data such as the rented title is then transmitted from the machine 230 to the central controller 302 via the network 301. It will be understood that central servers in general, such as the central controller 302, are often distributed. A plurality of central servers/controllers 302 may optionally be arranged in “load balanced” architecture to improve the speed and efficiency of the network. To accomplish the implementation of multiple controllers 302, the controllers 302 may be in communication with a router/distributor 303.

The central controller 302 is also in communication with a central database 304. The central database 304 stores information regarding the transaction network. For example, the central database 304 stores data regarding the vending inventory at each of the plurality of article dispensing machines 230. The central database 304 also stores sales information regarding the sales quantities of the vending merchandise stored in the machines 230. For example, the central database 304 stores information regarding the sales totals for each title and for each machine 230 vending location. Central database 304 also stores user information and rental transaction information, such as user IDs, the date on which discs are due to be returned, the date on which discs were rented from the machines 230 and a list of valid coupon codes and restrictions associated with those codes. In certain embodiments, central database 304 also may be configured to store user PINs. Some of this information is also preferably stored in article dispensing machine database 282.

Central database 304, which may include a ticketing database 358, is preferably a relational database, although other types of database architectures may be used without departing from the principles of the present invention. For example, the database 304 may be a SQL database, an Access database, or an Oracle database, and in any such embodiment have the functionality stored herein. Central database 304 is also preferably capable of being shared, as illustrated, between a plurality of central controllers 302 and its information is also preferably capable of being transmitted via network 301. It will be understood that a variety of methods exist for serving the information stored in central database 304. In one embodiment, .net and Microsoft Reporting Services are employed, however, other technologies such as ODBC, MySQL, CFML, and the like may be used.

The central controller 302 and central database 304 are also accessible by an electronic device 306, which may include a personal computer 102, mobile device 104 (e.g., smartphone, personal digital assistant, etc.), tablet computer 106, video game console 108, television 110, and Blu-Ray player 112. The electronic device 306 may be in direct or indirect communication with the central controller 302 and/or the central database 304 through a wired and/or wireless network connection, such as Ethernet, Wi-Fi, cellular (3G, 4G, etc.), or other type of connection. As a personal computer 102, the electronic device 306 will be understood as comprising hardware and software consistent with marketable personal and laptop computers, such as a display monitor, a keyboard, and a microprocessor. The electronic device 306 may also comprise Internet browser software such as Firefox, Internet Explorer, Chrome, or Safari. Using the browser software, a user of the electronic device 306 can access a website interface 360 through the central controller 302. An application may also execute on the electronic device 306 that accesses the central controller 302. To that end, central controller 302 preferably comprises web server software such as IIS or Apache. It will be understood that a variety of web server software and web browser software exists to implement the principles of the present invention without departing therefrom. Through the web browser software or application, the electronic device 306 communicates with the central controller 302 and allows the user to login to a central command functionality of the central controller 302 and to view and modify data stored in the central database 304. The browser interface or application also allows the user to perform certain system functions, which will affect the inventory and behavior of the article dispensing machines 230. The electronic device 306 may communicate with the central controller 302 and the central database 304 using rules and specifications of an application programming interface (API).

In a preferred embodiment, a financial server 305 is also in communication with the network 301. It will be understood that a variety of financial services exist for processing financial information via the Internet and other networks 301. Those services allow for the processing of credit card and debit card information, so that users of the services do not have to interface directly with credit and debit card companies. In FIG. 1, the financial server 305 is illustrated as a single server, although the financial server 305 may comprise an entire sub-network of financial servers 305 responsible for processing financial information.

As shown in FIG. 2, article dispensing machine 230 includes a machine housing 232 with front, rear, top, bottom, and side panels. The machine housing 232 is preferably a combination molded fiberglass and sheet metal cabinet. However, those skilled in the art will appreciate that the housing can be constructed from a variety of other suitable materials and with a variety of other suitable manufacturing techniques.

As shown most clearly in FIG. 2, a user interface portion 234 of housing 232 includes a card reader 240, a keypad and/or touch screen 242 and an article transfer opening 244. The card reader 240 is preferably designed in known fashion to read magnetically encoded membership and/or credit/debit cards for authorizing the distribution of articles of inventory through the article transfer opening 244. Keypad and/or touch screen 242 permits consumers and/or inventory stocking personnel to communicate with the dispensing machine 230 and/or a central office linked in electrical communication with the dispensing machine. Keypad and/or touch screen 242 also permits consumers and/or inventory stocking personnel to enter appropriate commands directed to carrying out specific machine tasks. It will be appreciated that the optional touch screen includes a monitor made with known technologies making it capable of being utilized as a user interface for entry of commands designed to carry out machine tasks. The touch screen 242 may also be capable of displaying a QR (Quick Response) code to a customer. The customer may read the QR code with a camera on a mobile device or with a dedicated QR code reader. The QR code can represent a universal resource locator (URL) to access a digital media selection, to represent a reference number for use by the customer when contacting customer service, or can be used to communicate a reminder notification for an event, for example.

Furthermore, it will be appreciated that additional user interface portions having additional or even identical user interface components could be incorporated within article dispensing machine 230. For example, these components could be incorporated on other panels of the housing 232 of machine 230 so that the machine can be used simultaneously by multiple consumers, translating into more efficient distribution of articles in high traffic areas. Dispensing machine 230 also preferably includes speaker units. Known audio technology may be incorporated within dispensing machine 230 to broadcast focused audio directed to relatively small (e.g., three square feet) locations in front of the machines from speaker units and/or in other designated locations at a retail site.

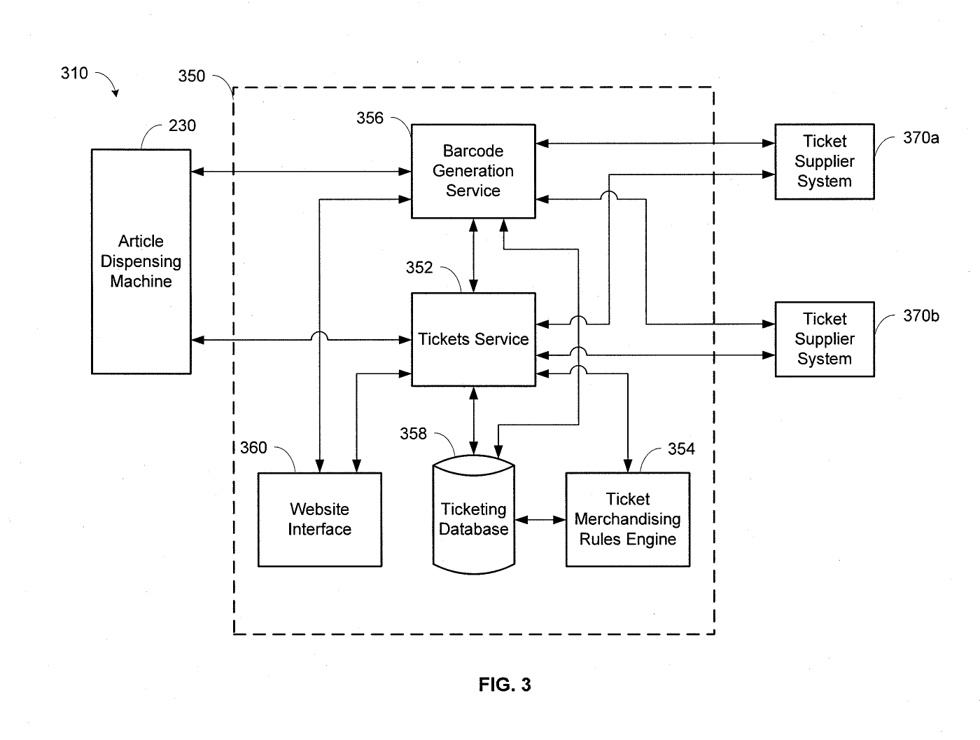

FIG. 3 illustrates a networked event ticketing system 310 including one or more article dispensing machines 230, an event ticketing management system 350, and ticket supplier systems 370a and 370b. The networked event ticketing system 310 provides for a variety of processes involving management, tracking, generation, and notification related to events, including processes related to the present invention. The networked event ticketing system 310 allows for direct and indirect communication between the components in the networked event ticketing system 310 via one or more networks. The components in the networked event ticketing system 310 may be operated by one or more entities. In one embodiment, the article dispensing machine(s) 230 and the event ticketing management system 350 are operated by a first entity, such as the operator of the article dispensing machines, while the ticket supplier systems 370a and 370b are operated by a second entity, such as a ticket supplier. A ticket supplier may include, for example, an event promoter, a venue, or other entity. In another embodiment, all of the components shown in the networked event ticketing system 310 of FIG. 3 are operated by the same entity.

Events may include at least sporting events, concerts, plays, musicals, movies, amusement parks, museums, and other attractions. Each event can include one or more productions, which are particular performances of the event at certain days, times, and/or venues. A ticket for an event may include a reserved seat ticket, a general admission ticket, a multi-day ticket, an open-ended ticket, and/or other type of ticket. The ticket supplier systems 370a and 370b can provide, publish, and allocate ticket inventory for any number of events and their associated productions to the event ticketing management system 350. The ticket inventory can include tickets that provide admission to and/or reserved seating at the events for holders of the tickets. Although FIG. 3 shows two ticket supplier systems 370a and 370b for simplicity, it is contemplated that any number of ticket supplier systems may be in communication with the event ticketing management system 350.

The event ticketing management system 350 includes components that can communicate information, such as ticket inventory availability and other data, to and from the article dispensing machines 230. Components in the event ticketing management system 350 also communicate information to and from the ticket supplier systems 370a and 370b. These components are described in further detail below. It will be understood that components 352, 354, 356 and 360 in the event ticketing management system 350 may be implemented, for example, by the central controller 302 using instructions stored in a memory connected to the central controller 302. It will be further understood that the ticketing database 358 may be implemented as part of the central database 304 or as a separate database.

The article dispensing machines 230 can communicate with the event ticketing management system. 350, including the central server and controller 302, via network communication equipment and circuitry, as detailed above. Furthermore, the event ticketing management system 350 can communicate with the ticket supplier systems 370a and 370b via the same or different network communication equipment and circuitry. In particular, the event ticketing management system 350 can manage information regarding event ticketing between the ticket supplier systems 370a and 370b and the article dispensing machines 230. It will also be understood that while a preferred embodiment of the present invention is for the components of the system 310 to have a “broadband” connection with one another, the principles of the present invention are also practicable with a dialup connection using a standard modem. Wireless network connections are also contemplated, such as wireless Ethernet, satellite, infrared, radio frequency, Bluetooth, near field communication, and cellular networks.

Each of the article dispensing machines 230 may operate without requiring continuous connectivity and communication with the central controller 302. In one embodiment, the central controller 302 only transmits data in response to communication from an article dispensing machine 230. For example, an article dispensing machine 230 may attempt to communicate with the central controller 302 to query the ticketing database 358 regarding the availability of tickets for an event. In another embodiment, the article dispensing machine 230 continues normal operations and transactions even if communication is interrupted or cannot be established with the central controller 302. Communication with the central controller 302 may be interrupted if the load at the central controller 302 is above a certain threshold. For example, the central controller 302 may direct the article dispensing machine 230 to only transmit certain types of messages and/or transactions, e.g., financial authorizations, until the load has decreased. In these cases, transaction data can be stored locally in the article dispensing machine 230, such as in the article dispensing machine memory storage device 281, until a predetermined time interval elapses, when a predetermined number of transactions is reached, until communication with the central controller 302 can be reestablished, or the load at the central controller 302 has decreased. Once communication is established with the central controller 302, financial and inventory information can be uploaded and the appropriate servers and databases can be updated.

In a further embodiment, the article dispensing machine 230 may periodically communicate with the event ticketing management system 350 to add, delete, and/or update information related to events. For example, the article dispensing machine 230 may communicate with the event ticketing management system 350 every three hours to ensure that the article dispensing machine 230 has the most relevant and up-to-date information regarding events. The information related to events may include event details (e.g., descriptions), event artwork, categories, production dates and times, venue, age ratings, reviews, and/or other information. The events available for transactions at the article dispensing machines 230 can be derived from prospective events. The event ticketing management system 350 can review the prospective events to determine whether a particular prospective event and/or its associated productions should be included in a listing of events at the article dispensing machines 230.

A tickets service 352 in the event ticketing management system 350 can be configured to communicate with the article dispensing machine 230 and the ticket supplier systems 370a and 370b. The tickets service 352 can be accessed during a ticket order transaction through the article dispensing machine 230 and/or the website interface 360. The ticket order transaction can be completed using a series of interface pages on a user interface 234 of the article dispensing machine 230, for example. By using the series of interface pages, a user of the article dispensing machine 230 may quickly and easily complete a ticket order transaction independently without the need for external assistance. By requiring the user to make a minimal number of decisions on each of the interface pages, the user's experience with the ticket order transaction may be simplified.

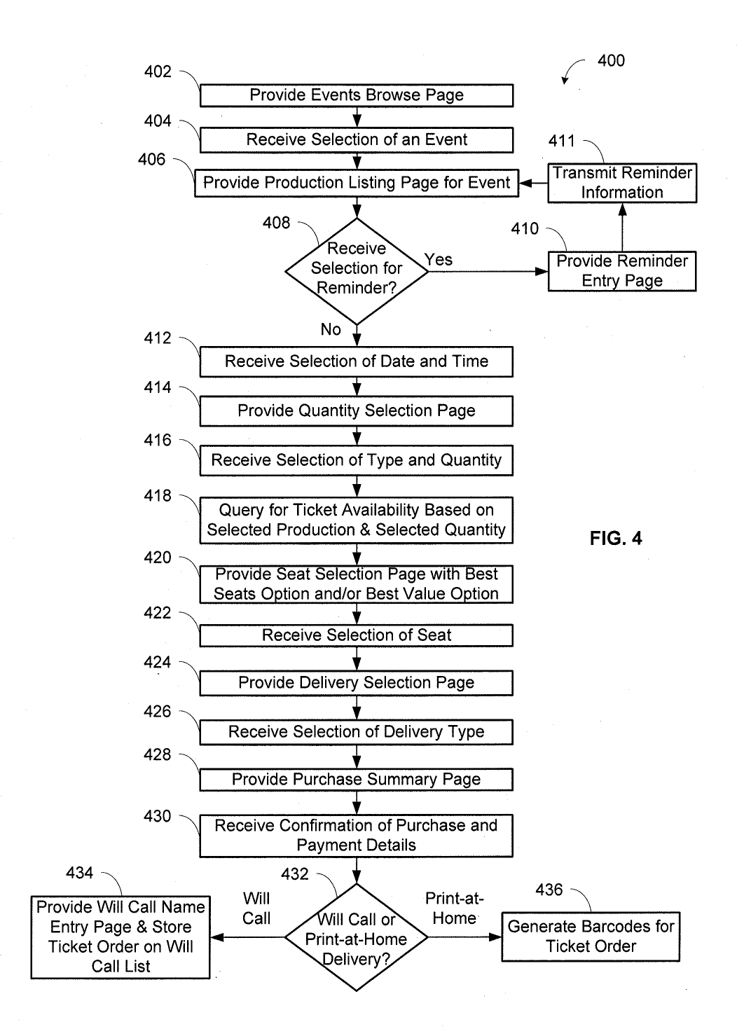

An embodiment of a process 400 for managing a ticket order transaction at an article dispensing machine 230 is shown in FIG. 4, and is described below. A user can utilize the article dispensing machine 230 to perform transactions related to renting or purchasing media articles (e.g., DVDs, Blu-Ray discs, and video game discs), digital media selections (e.g., streaming, downloadable, and on-demand media), and event ticketing. To enable such transactions, a merchandising page can be displayed on the user interface 234. The merchandising page may be configured as a “carousel” such that artwork and/or descriptions for the merchandise, i.e., media articles, media selections, and/or event ticketing, can be dynamically displayed. Each displayed piece of merchandise can be selected by a user on the user interface 234 to begin a transaction involving the piece of merchandise. In one embodiment, the merchandising page may be initially displayed on the user interface 234, prior to any user interaction with the article dispensing machine 230.

The “carousel” may periodically change so that multiple pieces of merchandise can be displayed for periodic intervals. Certain pieces of merchandise can be enlarged or otherwise highlighted, such as the displayed piece of merchandise in the center of the user interface 234. For example, the event “Dralion Cirque du Soleil” is highlighted for ticketing in FIG. 7. In some embodiments, the quantity of certain types of merchandise can be limited so that not all of the displayed pieces of merchandise are of the same type. The types of merchandise can also be alternated so that pieces of merchandise of the same type are not necessarily displayed next to one another. Instead of selecting a displayed piece of merchandise to begin a transaction, a user may also select an appropriate button to browse the particular type of merchandise, e.g., tickets, games, or movies. Other buttons may be available on the merchandising page to return media articles or perform reservation pickups, for example.

If the tickets button is accessed to browse for event tickets, an events browse page can be displayed on the user interface 234 at step 402 of the process 400. The events browse page can include selectable listings of one or more events that are available for ticketing at the article dispensing machine 230. The selectable listings can each include event artwork, an event title, an event description, a ticket price range, an average ticket price, and/or other information. The selectable listings on the events browse page may be curated by the tickets service 352 for the particular article dispensing machine 230. A selectable listing can be displayed with a flag to highlight and showcase the listing, such as if the event is today (“Today!”), ending soon (“Last Chance!”), and/or for other reasons. In some embodiments, certain events can be manually designated as a “Top Pick” so that these events are highlighted and showcased. An event designated as a “Top Pick” may include major events, such as events involving professional sports teams and popular musicians, for example. Further details of the management of ticket order transactions and curating of listings of events on an article dispensing machine 230 are described in a concurrently filed patent application entitled “System and Method for Event Ticketing Utilizing an Article Dispensing Machine”, Attorney Docket Number 019638.30US1, which is herein incorporated by reference in its entirety.

A user can sort and filter the selectable listings of events on the events browse page by selecting a category button. For example, if the sports category button is selected, the events browse page may display only events related to sports. The user can also sort and filter the selectable listings of events on the events browse page by selecting a button relating to the date range (e.g., soonest, this weekend, next week, etc.), price, alphabetical order (e.g., A-Z), or other criteria. In some embodiments, a text entry field (not shown) can be displayed on the events browse page so that a user can directly search for a specific event and/or production. A selectable button may also be included on the events browse page to allow the user to access a tutorial page (not shown) describing how to utilize the article dispensing machine 230 for a ticket order transaction.

In certain embodiments, the selectable listings on the events browse page can be based on a transaction history of the user of the article dispensing machine 230. The transaction history may include the rental or purchase history of a media article or media selection, for example, such that the selectable listings of events can be related to one or more rentals or purchases. In one embodiment, if the user enters a unique customer identifier at the user interface 234 of the article dispensing machine 230, such as by swiping a credit card or debit card, the article dispensing machine 230 may query the tickets service 352 to retrieve the transaction history of the user. Based on the transaction history, the article dispensing machine 230 can determine which events to display in the selectable listings. Certain events may also be highlighted and showcased, based on the transaction history. For example, if the user has previously rented or is currently renting the movie “Cinderella”, one of the selectable listings of an event that is shown, highlighted, or showcased may be “Disney Stars on Ice”. Other pieces of merchandise may also be highlighted or showcased based on a ticket order transaction. For example, if the user purchases tickets to an NFL football game, the video game Madden NFL and/or a DVD for NFL Football Follies may be highlighted or showcased. The selection of a particular event on the events browse page can be received by the article dispensing machine 230 at step 404.

A production listing page for a particular event can be displayed on the user interface 234 at step 406 when a selectable listing for the particular event is selected from the events browse page and received at step 404. The production listing page for a particular event may also be displayed on the user interface 234 if the particular event is selected from the merchandising page. The production listing page may include the event name, event artwork, an event description, and a production listing. The event description may include a description of the event and/or whether there are any applicable age restrictions for admission to the event. If an event with an age restriction is selected, an age restriction warning page (not shown) may be displayed on the user interface 234 so that the user can acknowledge that there is an age restriction for the event. The event description may also include information on any secondary acts, such as an opening act for a concert.

The production listing can include selectable listings for one or more productions at their respective dates, times, and venues for when the particular event is to be performed and for which tickets are available. The price ranges and/or average price of the available tickets for each of the productions can also be included in the production listing. If more production listings are available than can be shown at one time, pagination buttons can be selected to access the additional production listings. A selectable calendar view button may be selected on the production listing page to list the productions in a calendar format for selection by the user. The calendar format may include a daily, weekly, and/or monthly format that shows the production listings. If one of the selectable listings is selected by a user on the user interface 234, a current selection can be displayed that includes information regarding which of the selectable listings has been selected. The selected production listing can also be highlighted, such as with a colored checkmark, for example. The production listing page can also include a next or continue button to continue with the ticket order transaction, or a browse or back button to return to the events browse page. The selection of a particular production on the production listing page can be received by the article dispensing machine 230 at step 412, if a reminder button is not selected at step 408.

The production listing page may further include a reminder button (or “email info”) that can be selected on the user interface 234 at step 408. If selected, the reminder button can result in the display of a reminder entry page at step 410 on the user interface 234. The reminder entry page can include a communication input field for allowing the user to input an email address, phone number, or other communication address. The user may enter the communication address with an on-screen keyboard, hardware keyboard, or other input device. When completed, the reminder entry page can cause the article dispensing machine 230 or the tickets service 352 to transmit a reminder notification to the communication address via email, SMS/text messaging, or other medium. The reminder notification can include the event information and/or a URL to the website interface 360 to continue the ticket order transaction. For example, the user may select the reminder button to receive the reminder notification and complete the ticket order transaction later, such as if the user wishes to consult with other persons about the event. Once the communication input field is completed, a continue button can be selected to transmit the reminder at step 411 and then return to displaying the production listing page at step 406. If the user does not wish to utilize the reminder entry page, a no thanks button can be selected to return to the production listing page.

In some embodiments, a tracking identifier can be stored when a reminder notification is transmitted. The tracking identifier can uniquely identify the particular article dispensing machine 230, the ticket order transaction, a partner associated with the article dispensing machine 230 (e.g., the retailer where the article dispensing machine 230 is located), and/or other information. This information can be used to assist the user in completing the ticket order transaction on a different platform other than the article dispensing machine 230, e.g., the website interface 360. This information can also be used to properly attribute a completed ticket order transaction to the particular article dispensing machine 230 and/or the partner, in accordance with contractual agreements.

A quantity selection page can be displayed on the user interface 234 at step 414 when a particular desired production has been selected on the production listing page at step 412. The quantity selection page can include production information (e.g., date, time, price ranges, average price, venue, event artwork, etc.) and one or more ticket quantity input elements. A ticket quantity input element can be displayed for each type of ticket group (e.g., adult, child, senior, military, etc.) for the event and the associated production. A type of ticket group can also include ticket packages with add-ons to the tickets, e.g., parking passes, food packages, etc. If more types of ticket groups are available than can be shown at one time, pagination buttons can be selected to access additional ticket quantity input elements for the additional types of ticket groups. The user can specify the desired quantity of tickets for each type of ticket group for the desired production using the ticket quantity input elements. The desired quantity can be limited to minimum and/or maximum quantities, based on contractual obligations or other factors. The ticket quantity input elements can include increment and decrement buttons, as shown, and/or may include direct numerical entry of the desired quantity. The quantity selection page can also include a next or continue button to continue with the ticket order transaction, a browse or back button to return to the events browse page, and/or a change date button to return to the production listing page. The selection of a desired quantity and type of ticket group on the quantity selection page can be received by the article dispensing machine 230 at step 416.

After the quantity selection page is completed at step 416, the article dispensing machine 230 can access the tickets service 352 at step 418 to retrieve a ticket availability, based on the desired quantity entered on the quantity selection page for the desired production. The article dispensing machine 230 may access the tickets service 352 to query the ticketing database 358 and/or the pertinent ticket supplier system 370a and 370b at step 418 in real-time to determine whether tickets for the desired production are available at the desired quantity. The tickets service 352 can return the ticket availability to the article dispensing machine 230. If the article dispensing machine 230 is not able to access the tickets service 352, e.g., if there is no network availability, then the tickets order can be cancelled and an error page can be displayed on the user interface 234.

A seat selection page can be displayed on the user interface 234 at step 420 and can include the ticket availability received at step 418. The ticket availability may include a best seats option and/or a best value option. Each of the best seats option and the best value option may include the section, row, seat, and/or other seat location information, as well as the quantity of tickets in the ticket order transaction, the price of the tickets, and/or total price of the ticket order transaction. The best seats option may be the highest ranking available ticket, which can be determined by whether the corresponding seats are closest to the stage, court, field, etc., for example, regardless of ticket price. The particular seats (and their section, row, etc.) may have been previously assigned a particular ranking based on objective and/or subjective information regarding the enjoyment and satisfaction of spectators in the particular seats for the event or venue. For example, seats closer to the stage for concerts or to the field for baseball games may have a higher ranking that seats farther away from the stage or field. In some embodiments, the best seats option may include seats with the largest available inventory, if the only available tickets are at the same price.

The best value option may be the lowest price available ticket, regardless of seat location. In some embodiments, the best value option may take into account the ranking of the seat location. In other embodiments, more than one best seat option and/or more than one best value option may be displayed on the seat selection page. For example, if the only available seats for a production are at one price, then multiple best seat options can be displayed where the primary best seat option has a higher ranking and the secondary best seat option has a lower ranking.

The seat selection page can also include a venue map for assisting the user in identifying the location in the venue of the sections, rows, etc. of the available tickets. The venue map may be zoomable so that details of the seating locations can be discerned. A selectable venue info button can also be selected to display further detailed information about the venue, such as location, travel directions, public transportation information, box office times, etc. The seat selection page can also include a next or continue button to continue with the ticket order transaction, a browse or back button to return to the events browse page, and/or a change quantity button to return to the quantity selection page. In some embodiments, the seat selection page can include an interactive seat map configured to allow the user to select an available seat, section, row, etc. The selection of a seat on the seat selection page can be received by the article dispensing machine 230 at step 422.

Following the selection of seats on the seat selection page at step 422, the article dispensing machine 230 can display a delivery selection page on the user interface 234 at step 424. The delivery selection page can allow the user to select how the tickets from the ticket order transaction are to be delivered to the user. A print-at-home option and a will call option may be shown, but other delivery options are contemplated, such as mobile device delivery. If selected, the print-at-home option allows the user to later print the tickets of the ticket order transaction on a printer, for example. The will call option allows the user to pick up the tickets for the production at the venue. The delivery selection page can also include an ok button to continue with the ticket order transaction and a back button to return to the seat selection page. The selection of a delivery option on the delivery selection page can be received by the article dispensing machine 230 at step 426.

A purchase summary page can be displayed on the user interface 234 at step 428 following the selection of a delivery option on the delivery selection page at step 426. The purchase summary page can include a summary of the ticket order transaction, such as event details (e.g., description, date, time, venue, artwork, etc.), ticket prices, total prices, taxes, fees, and/or other information. A pay button can be selected on the purchase summary page to complete the ticket order transaction. The purchase summary page can also include a start over button to cancel the current ticket order transaction and start a new ticket order transaction. A terms and privacy button may also be included on the purchase summary page so that the user can access terms and conditions and/or the privacy policy relating to the ticket order transaction. Payment pages (not shown) may also be displayed on the user interface 234 at step 428 to receive payment at step 430 from the user at the article dispensing machine 230. Payment from the user may include charging the total price of the ticket order transaction to a credit card or a debit card, redeeming credits, promotion codes, and/or gift cards, utilizing electronic payments (e.g., Google Wallet, PayPal, etc.), group ticket purchasing, and/or other payment methods. In the case of charging a credit card or a debit card, the user may need to enter a zip code for the billing address of the credit card or debit card to process the payment. The article dispensing machine 230 may utilize the financial server 305, for example, to process the payment.

If the will call option was selected on the delivery selection page at step 432, one or more will call name entry pages can be displayed on the user interface 234 at step 434. The will call name entry pages can be initially populated with a name derived from the payment information, for example. However, because the person who purchased the tickets does not necessarily have to be the same person who picks up the tickets at the venue, the name of the person who will be picking up the tickets can be entered in a name entry field. The user may enter a name in the name entry field with an on-screen keyboard, hardware keyboard, or other input device. Generally, the person picking up the tickets at the venue will need to show an identification card (e.g., driver's license, school identification card, etc.) that matches the name entered on the will call name entry page, in order to pick up the tickets. The completion of the will call name entry page can result in storing the ticket order transaction on a will call list at step 434. The will call list can be stored in the ticketing database 358 and/or transmitted to the pertinent ticket supplier system 370a and 370b.

Following completion of the will call name entry page at step 434, or if the print-at-home option was selected on the delivery selection page, the article dispensing machine 230 can display an order confirmation communication page on the user interface 234. The order confirmation communication page can include a communication input field for allowing the user to input an email address, phone number, or other communication address. The user may enter the communication address with an on-screen keyboard, hardware keyboard, or other input device. A done button can be selected on the user interface 234 to denote completion of the order confirmation communication page and the ticket order transaction. Completion of the order confirmation communication page can cause the article dispensing machine 230 or the tickets service 352 to transmit a ticket order confirmation related to the ticket order transaction to the communication address via email, SMS/text messaging, or other medium. The tickets service 352 may also transmit the information related to ticket order transaction to the pertinent ticket supplier system 370a and 370b at steps 434 or 436, as applicable. The information related to the ticket order transaction may include, for example, the locations of the seats, barcode information, and/or will call information (if applicable) so that the ticket supplier and/or the venue is informed of the sale of tickets to the production of the event. In this way, the ticket supplier system 370a and 370b and/or the venue will know to admit the bearers of the tickets when the ticket is presented at the production of the event. In addition, the tickets service 352 may store some or all of the information related to the ticket order transaction in the ticketing database 358. In the case of the print-at-home delivery option, the barcode information may be generated at step 436 prior to being transmitted to the pertinent ticket supplier system 370a and 370b.

A barcode generation service 356 in the event ticketing management system 350 can be configured to communicate with the tickets service 352. In some embodiments, the barcode generation service can be configured to communicate with the article dispensing machine 230 and the ticket supplier systems 370a and 370b. The barcode generation service 356 can be accessed following a ticket order transaction that has been performed through the article dispensing machine 230 and/or the website interface 360. In particular, if the ticket order transaction includes the print-at-home option or printing of the tickets on the article dispensing machine 230, a ticket barcode for each of the tickets of the ticket order transaction may be generated at step 436. The ticket barcodes for the tickets may conform to the requirements of the venue for the production of the event. After ticket barcodes for the tickets are generated, the barcode generation service 356 may transmit the ticket barcodes to the pertinent ticket supplier system 370a and 370b so that the ticket supplier and/or the venue is informed of the barcodes for admission control purposes. The user experience for purchasing tickets from disparate ticket suppliers and/or venues can therefore be simplified and streamlined. Moreover, a user purchasing tickets through the event ticketing system 310 may have an improved customer service experience in that there may be a single point of contact, e.g., the operators of the event ticketing management system 350, for any issues concerning the ticket order.

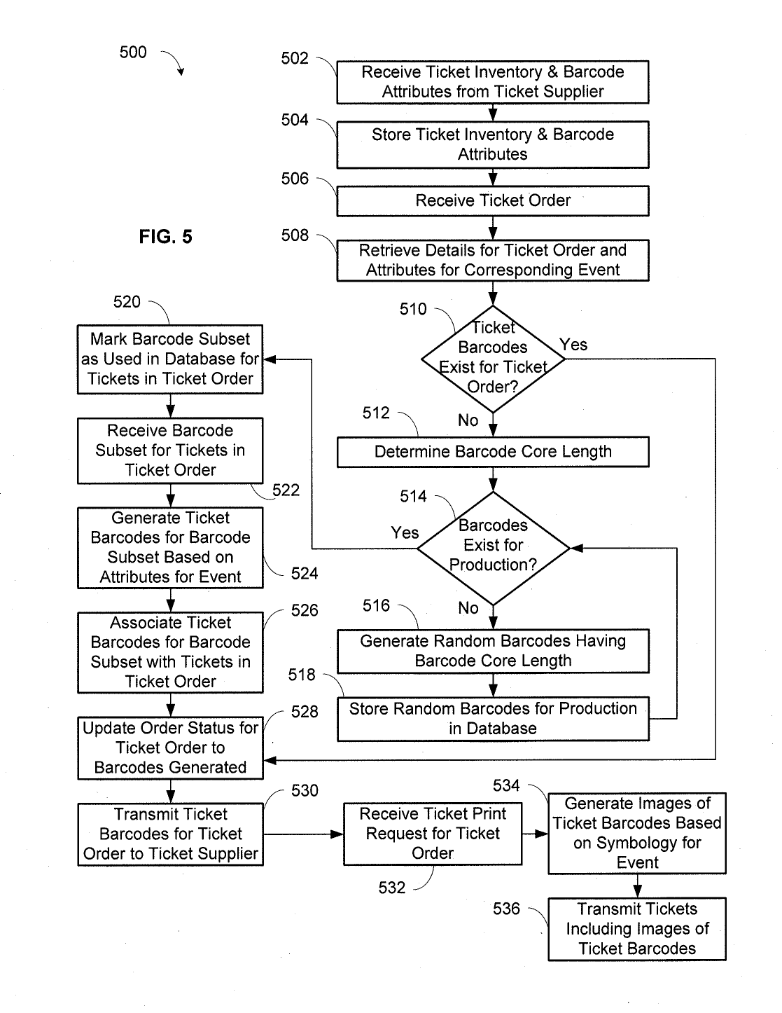

An embodiment of a process 500 for dynamically generating ticket barcodes for tickets of a ticket order is shown in FIG. 5. The process 500 can be performed as part of step 436 of the process 400 when a print-at-home delivery option is selected as part of a ticket order transaction, for example. The process 500 may also be performed for generating ticket barcodes that are included in tickets printed at an article dispensing machine 230, in some embodiments. The process 500 can result in the generation of tickets including the appropriate ticket barcodes for a particular production of an event at a venue. The process 500 can also generate a number of random barcodes for productions of an event at a venue, and these random barcodes can be the basis for the ticket barcodes that are later included in the tickets. Tickets provided by primary ticketing suppliers may be especially suited to be used in the process 500 because primary ticketing suppliers typically maintain their own barcode standards, e.g., barcode attributes, for a variety of venues.

At step 502, ticket inventory and/or barcode attributes may be received from a ticket supplier system 370a and 370b, such as via the credits system 352. In some embodiments, the attributes may be received directly from the ticket supplier system 370a and 370b. The ticket supplier system 370a and 370b may transmit a ticket inventory and/or barcode attributes, on a scheduled or unscheduled basis. The ticket inventory may include allocations of tickets for productions of one or more events that are at one or more venues. Barcode attributes may be unique to each ticket supplier system 370a and 370b and may include a barcode prefix, a barcode suffix, a barcode total length, a barcode symbology, and/or other attributes. The barcode prefix, barcode suffix, and barcode total length may be attributes of the underlying data that a particular ticket barcode represents. Each ticket barcode can be of the barcode total length and may include the barcode prefix concatenated with a random barcode concatenated with the barcode suffix. The underlying data may include alphanumeric characters, for example. In this way, a unique ticket barcode can be generated for each ticket of a ticket order transaction, while still conforming to the specific requirements of a particular ticket supplier system.

The barcode symbology may relate to the images of the ticket barcodes and define the mapping between the underlying data and the images. The barcode symbology may include how the underlying data is encoded into the images of the ticket barcodes, such as the widths, lengths, spacing, interleaving, continuous or discrete, two-width or many-width, the use of checksums, the use of check digits, and/or other characteristics of the ticket barcodes. The ticket barcode may include a one-dimensional symbology, such as Code 128 and Interleaved 2 of 5, or a two-dimensional symbology, such as a QR Code, for example. The ticket inventory and the barcode attributes may be stored in the ticketing database 358 at step 504 for later usage in generating random barcodes and the ticket barcodes for ticket orders.

At step 506, a ticket order including one or more tickets may be received at the barcode generation service 356. The ticket order may be received at the barcode generation service 356 from the tickets service 352, the article dispensing machine 230, and/or the website interface 360. The ticket order may have been transacted by a user utilizing the tickets service 352 at an article dispensing machine 230 or website interface 360, using the process 400 described above, for example. The ticket order may include a production identifier that uniquely identifies a particular production of an event that is at a particular venue. Details associated with the ticket order and barcode attributes for the corresponding event and venue may be retrieved from the ticketing database 358 at step 508. The details associated with the ticket order may include whether ticket barcodes already exist for the ticket order. Ticket barcodes may exist for the ticket order in the ticketing database 358 if such ticket barcodes were previously generated, such as if the same ticket order were received more than once. Barcode attributes for the corresponding event may have been previously stored in the ticketing database 358 at step 504, for example. If ticket barcodes exist for the ticket order at step 510, then the process 500 can continue to step 528 to update the order status for the ticket order to denote that the ticket barcodes have been generated. However, if ticket barcodes do not exist for the ticket order at step 510, then the process 500 can continue to step 512.

A barcode core length can be determined at step 512, based on the length of the barcode prefix, the length of the barcode suffix, and the barcode total length that were retrieved as part of the barcode attributes for the event and venue at step 508. In particular, the barcode core length may be equal to the barcode total length minus the length of the barcode prefix minus the length of the barcode suffix. At step 514, it may be determined whether barcodes (of the barcode core length) exist in the ticketing database 358 for the particular production of the event. Barcodes may already exist in the ticketing database 358 if such barcodes had been previously generated for a previous ticket order, in anticipation of allocating the barcodes to future ticket orders. The barcodes may have been previously generated using steps 516 and 518, for example, as described below.

If barcodes do not exist for the production in the ticketing database 358 at step 514, then the process 500 may continue to step 516 to generate random barcodes having the barcode core length. A number of random barcodes may be generated at step 516, such as 2000 barcodes for the particular production. Not all of the random barcodes will be associated with the ticket order at step 516, but rather, the random barcodes can be generated as a seed for the current ticket order and/or future ticket orders. Moreover, the random barcodes generated at step 516 are not specific to any particular seat in the venue, but rather are specific to the production. Step 516 may also be performed if additional random barcodes are needed if a previously-generated seeding of random barcodes has been exhausted. The random barcodes for the particular production may be stored in the ticketing database 358 at step 518, and the process 500 may return to step 514.

If barcodes exist for the production in the ticketing database 358 at step 514, then the process 500 may continue to step 520 to mark a subset of the barcodes as used for the tickets in the ticket order. As mentioned above, barcodes may exist for the production if they were previously generated at step 516. The subset of the barcodes marked as used may include a subset of the random barcodes that were generated at step 516. The barcodes may be marked as used in the ticketing database 358 at step 520. The subset of the barcodes for the tickets in the ticket order may be received at step 522 from the ticketing database 358. At step 524, ticket barcodes may be generated for each of the subset of the barcodes, based on the barcode attributes for the associated event and venue. In particular, the ticket barcodes may include the barcode prefix concatenated with each barcode in the subset concatenated with the barcode suffix. The length of the ticket barcode may be the barcode total length.

The barcode prefix, the barcode suffix, and/or the barcode total length may be selected such that the ticket barcodes generated at step 524 will not conflict with ticket barcodes generated by other sources, such as the ticket supplier systems 370a and 370b. For example, the barcode prefix and/or the barcode suffix may be unique to the event ticketing management system 350 so that even if the random barcode (included as the “core” of the ticket barcode) is repeated by another source, the ticket barcode as a whole will be unique. As another example, the barcode total length for tickets generated by the event ticketing management system 350 may be a different length from tickets supplied from other sources. In some embodiments, the attributes for the event may not include a barcode prefix and/or a barcode suffix.

At step 526, the ticket barcodes generated at step 524 may be associated in the ticketing database 358 with the tickets in the ticket order. Associating the ticket barcodes with the tickets enables the event ticketing management system 350 to know that the particular ticket barcodes can be used for the particular tickets when the tickets are printed, for example, as described below. The order status for the ticket order may be updated in the ticketing database 358 to indicate that barcodes have been generated at step 528. At step 530, the ticket barcodes generated for tickets in the ticket order may be transmitted to the pertinent ticket supplier system 370a and 370bIn this way, the ticket supplier and/or the venue can be informed that the particular ticket barcodes are acceptable for admission to the production of the event associated with the ticket order. In other words, when a ticket bearing an image of the ticket barcodes is scanned at the venue, the bearer of the ticket can gain admission to the production of the event. The ticket barcodes may be transmitted at step 530 as a batch transfer, in real-time, as text files, as spreadsheets, and/or using other methods.

A ticket print request for the ticket order may be received at step 532. The ticket print request may be received at the barcode generation service 356 from an electronic device 306 via the tickets service 352, and/or directly from the electronic device 306, such as through the website interface 360. An article dispensing machine 230 may also transmit the ticket print request. At step 534, images of the ticket barcodes corresponding to the tickets in the ticket order may be generated, based on the symbology for the event and venue from the barcode attributes. The ticket barcodes for the tickets in the ticket order may be retrieved from the ticketing database 358 and the images for the ticket barcodes may then be generated.

At step 536, the tickets may be transmitted from the event ticketing management system 350, and may include the images of the ticket barcodes generated at step 534. The tickets may be based on a generic template and/or a template specific to the event or venue. The tickets may also include information other than the ticket barcode, such as event information (e.g., date, time, venue, artwork, etc.), gate information, branding, advertisements, and/or other information. The tickets may be transmitted as a graphic file (e.g., PDF, JPG, etc.), or in another appropriate format so that the tickets can be printed and/or viewed. For example, if a user transmits the ticket print request from a computer at step 532, then the tickets transmitted at step 536 may be in a PDF file so that the tickets can be saved and/or printed. As another example, if a user transmits the ticket print request from a smartphone at step 532, then the tickets may be transmitted at step 536 as a graphic file and/or as part of a webpage so that the tickets can be viewed on the screen of the smartphone for scanning purposes.

Any process descriptions or blocks in figures should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

1. A method of dynamically generating a ticket barcode for one or more tickets of a ticket order, each of the one or more tickets for admission to an event at a venue, using a processor in communication with a network, the method comprising:
receiving the ticket order at the processor, the ticket order comprising a production identifier for uniquely identifying a production of the event and the venue;
retrieving barcode attributes associated with the venue from a database to the processor, the barcode attributes comprising a barcode prefix, a barcode suffix, a barcode total length, and a barcode symbology;
determining a barcode core length comprising a length of the barcode prefix and a length of the barcode suffix each subtracted from the barcode total length, using the processor;
generating a plurality of random barcodes for the production, using the processor, wherein each of the plurality of random barcodes has the barcode core length, and each random barcode of the plurality of random barcodes is unique as to each other;
storing, in the database, the plurality of random barcodes for the production, using the processor;
marking as used a subset of the plurality of random barcodes in the database, using the processor, the subset associated with the one or more tickets in the ticket order;
receiving the subset of the plurality of random barcodes from the database at the processor;
generating the ticket barcode for each random barcode of the subset of the plurality of random barcodes, using the processor, wherein the ticket barcode has the barcode total length, and wherein the ticket barcode comprises the random barcode of the subset of the plurality of random barcodes;
associating, in the database, the ticket barcode for each of the subset of the plurality of random barcodes with each of the one or more tickets in the ticket order, using the processor; and
generating an image of the ticket barcode for each of the subset of the plurality of random barcodes, based on the barcode symbology, using the processor.

2. The method of claim 1, wherein the ticket barcode further comprises one or more of the barcode prefix or the barcode suffix, and wherein the ticket barcode comprises the barcode prefix concatenated with the random barcode of the subset of the plurality of random barcodes concatenated with the barcode suffix.

3. The method of claim 1:
further comprising receiving at the processor a ticket print request for the ticket order;
wherein generating the image of the ticket barcode comprises generating the image of the ticket barcode for each of the subset of the plurality of random barcodes, based on the barcode symbology, in response to receiving the ticket print request, using the processor.

4. The method of claim 3, further comprising transmitting from the processor the one or more tickets comprising the image of the ticket barcode for each of the subset of the plurality of random barcodes.

5. The method of claim 4, wherein transmitting the one or more tickets comprises transmitting from the processor to an article dispensing machine the one or more tickets comprising the image of the ticket barcode for each of the subset of the plurality of random barcodes.

6. The method of claim 1, further comprising:
receiving a ticket inventory and the barcode attributes at the processor from a ticket supplier system, wherein the ticket inventory comprises data representing the event, the production of the event, and the venue; and
storing the ticket inventory and the barcode attributes in the database, using the processor.

7. The method of claim 1:
further comprising determining whether the ticket barcode exists in the database for each of the one or more tickets in the ticket order, using the processor;
wherein:
determining the barcode core length comprises determining the barcode core length comprising the length of the barcode prefix and the length of the barcode suffix each subtracted from the barcode total length, using the processor, if the ticket barcode does not exist in the database for each of the one or more tickets in the ticket order; and
generating the image comprises generating the image of the ticket barcode for each of the subset of the plurality of random barcodes, based on the barcode symbology, using the processor, if the ticket barcode exists in the database for each of the one or more tickets in the ticket order.

8. The method of claim 1:
further comprising determining whether the plurality of random barcodes exist in the database for the production, using the processor;
wherein:
generating the plurality of random barcodes comprises generating the plurality of random barcodes for the production, using the processor, wherein each of the plurality of random barcodes has the barcode core length, if the plurality of random barcodes do not exist in the database for the production; and
marking as used the subset comprises marking as used the subset of the plurality of random barcodes in the database, using the processor, the subset associated with the one or more tickets in the ticket order, if the plurality of random barcodes exist in the database for the production.

9. The method of claim 1, further comprising transmitting from the processor to a ticket supplier system the ticket barcode for each of the one or more tickets in the ticket order.

10. The method of claim 1, further comprising updating an order status of the ticket order in the database, using the processor, the order status denoting that the ticket barcode for each of the one or more tickets in the ticket order has been generated.

11. The method of claim 1, wherein:
the ticket barcode represents one or more alphanumeric characters;
the image of the ticket barcode comprises one or more of a one dimensional barcode or a two dimensional barcode; and
the barcode symbology comprises one or more of a one-dimensional symbology or a two-dimensional symbology.

12. A system for dynamically generating a ticket barcode for one or more tickets of a ticket order, each of the one or more tickets for admission to an event at a venue, the system comprising:
a processor in communication with a network;
a memory in communication with the processor, the memory for storing:
a database; and
a barcode generation service for:
receiving the ticket order, the ticket order comprising a production identifier for uniquely identifying a production of the event and the venue;
retrieving barcode attributes associated with the venue from the database, the barcode attributes comprising a barcode prefix, a barcode suffix, a barcode total length, and a barcode symbology;
determining a barcode core length comprising a length of the barcode prefix and a length of the barcode suffix each subtracted from the barcode total length;
generating a plurality of random barcodes for the production, wherein each of the plurality of random barcodes has the barcode core length, and each random barcode of the plurality of random barcodes is unique as to each other;
storing, in the database, the plurality of random barcodes for the production;
marking as used a subset of the plurality of random barcodes in the database, the subset associated with the one or more tickets in the ticket order; receiving the subset of the plurality of random barcodes from the database;
generating the ticket barcode for each random barcode of the subset of the plurality of random barcodes, wherein the ticket barcode has the barcode total length, and wherein the ticket barcode comprises the random barcode of the subset of the plurality of random barcodes;
associating, in the database, the ticket barcode for each of the subset of the plurality of random barcodes with each of the one or more tickets in the ticket order; and
generating an image of the ticket barcode for each of the subset of the plurality of random barcodes, based on the barcode symbology.

13. The system of claim 12, wherein the ticket barcode further comprises one or more of the barcode prefix or the barcode suffix, and wherein the ticket barcode comprises the barcode prefix concatenated with the random barcode of the subset of the plurality of random barcodes concatenated with the barcode suffix.

14. The system of claim 12:
wherein the barcode generation service is further for receiving a ticket print request for the ticket order;
wherein the barcode generation service generates the image of the ticket barcode by generating the image of the ticket barcode for each of the subset of the plurality of random barcodes, based on the barcode symbology, in response to receiving the ticket print request.

15. The system of claim 13, wherein the barcode generation service is further for transmitting the one or more tickets comprising the image of the ticket barcode for each of the subset of the plurality of random barcodes.

16. The system of claim 15, wherein the barcode generation service transmits the one or more tickets by transmitting to an article dispensing machine the one or more tickets comprising the image of the ticket barcode for each of the subset of the plurality of random barcodes.

17. The system of claim 12, wherein the barcode generation service is further for:
receiving a ticket inventory and the barcode attributes from a ticket supplier system, wherein the ticket inventory comprises data representing the event, the production of the event, and the venue; and
storing the ticket inventory and the barcode attributes in the database.

18. The system of claim 12:
wherein the barcode generation service is further for determining whether the ticket barcode exists in the database for each of the one or more tickets in the ticket order;
wherein:
the barcode generation service determines the barcode core length by determining the barcode core length comprising the length of the barcode prefix and the length of the barcode suffix each subtracted from the barcode total length, if the ticket barcode does not exist in the database for each of the one or more tickets in the ticket order; and
the barcode generation service generates the image by generating the image of the ticket barcode for each of the subset of the plurality of random barcodes, based on the barcode symbology, if the ticket barcode exists in the database for each of the one or more tickets in the ticket order.

19. The system of claim 12:
wherein the barcode generation service is further for determining whether the plurality of random barcodes exist in the database for the production;
wherein:
the barcode generation service generates the plurality of random barcodes by generating the plurality of random barcodes for the production, wherein each of the plurality of random barcodes has the barcode core length, if the plurality of random barcodes do not exist in the database for the production; and
the barcode generation service marks as used the subset by marking as used the subset of the plurality of random barcodes in the database, the subset associated with the one or more tickets in the ticket order, if the plurality of random barcodes exist in the database for the production.

20. The system of claim 12, wherein the barcode generation service is further for transmitting to a ticket supplier system the ticket barcode for each of the one or more tickets in the ticket order.

21. The system of claim 12, wherein the barcode generation service is further for updating an order status of the ticket order in the database, the order status denoting that the ticket barcode for each of the one or more tickets in the ticket order has been generated.

22. The system of claim 12, wherein:
the ticket barcode represents one or more alphanumeric characters;
the image of the ticket barcode comprises one or more of a one dimensional barcode or a two dimensional barcode; and
the barcode symbology comprises one or more of a one-dimensional symbology or a two-dimensional symbology.
